(19) United States
(12) Patent Application Publication
(10) Pub. No.: US 2020/0218015 A1
(43) Pub. Date: Jul. 9, 2020

(54) FIBER OPTIC ADAPTER WITH DUST SHUTTER ASSEMBLY FOR REMOVING DEBRIS FROM A FERRULE ENDFACE

(71) Applicant: SENKO ADVANCED COMPONENTS, INC., Marlborough, MA (US)

(72) Inventors: MAN MING HO, KOWLOON (HK); KAZUYOSHI TAKANO, TOKYO (JP)

(73) Assignee: SENKO ADVANCED COMPONENTS, INC., MARLBOROUGH, MA (US)

(21) Appl. No.: 16/732,038

(22) Filed: Dec. 31, 2019

Related U.S. Application Data
(60) Provisional application No. 62/786,697, filed on Dec. 31, 2018.

(51) Int. Cl. G02B 6/38

(52) U.S. Cl. CPC G02B 6/3825; G02B 6/3866; G02B 6/3849

(57) ABSTRACT

A dust shutter plate biased by a spring plate closed within a port of an adapter assembly with one or more receptacle ports configured to received and secure a fiber optic connector. The dust shutter plate may be coated with a cloth or gel to reduce light transmission losses or both. The angle of the spring plate ensures the plate coated makes contact with the ferrule endface to remove debris and coat the optical fibers at the endface. And if not a coated dust plate, the spring is angled to ensure the ferrule endface does not contact the dust shutter plate surface and damage the optical fiber therein. The dust shutter plate may have a plural of grooves on the connector facing side of the shutter plate.

### CROSS-REFERENCE TO RELATED APPLICATION

The present invention claims priority to U.S. Provisional Patent Application No. 62/786,697, filed on Dec. 31, 2018, the disclosure of which is incorporated by reference herein.

### FIELD OF THE INVENTION

The present invention relates to optical adapters configured to receive one or more fiber optic connectors in general and, more particularly, to fiber optic adapters with a dust shutter or shutter assembly formed as part of the adapter housing for a ferrule tip from dust and other debris. The adapter housing is configured receive one or more fiber optic connectors having at least one optical fiber for transmitting light.

### BACKGROUND

Demand for bandwidth by enterprises and individual consumers continues to rise exponentially. To meet this demand, fiber optics have become the standard cabling medium. Fiber optics relies on individual optical fibers of glass or polymers that are on the order of 250 microns in diameter. Data centers use high-density cabling, with individual fiber optic cables containing one or more optical fibers. Typically, in these high-density environments, LC type or data center type fiber optic connectors are used with an adapter to interconnect an opposing LC type connector to establish a communication link between two or more network of fiber optic connectors. Fiber counts may be, for example, 8, 16, 32, or 64 fibers. Other connectors within a network may be a MPO optical connector. The MPO connector is a multi-fiber push-on, push-off connector. The LC connector is a two-ferrule fiber optic connector used in data center applications that likewise can be interfered with by debris being deposited on a ferrule endface that has one or more optical fibers exposed to the environment when not connected opposite another fiber optic connector or transceiver light source.

A prior art dust shutter plate, is disclosed in U.S. Pat. No. 6,561,699B1, “Plug Part of an Optical Plug-And-Socket Connection”, granted May 13, 2003 to Inventor De Marchi, at FIG. 15 discloses the shutter plate is forward in an adapter port.

### SUMMARY

A low profile dust shutter plate assembly with at least one dust shutter plate is configured to cover and protect an adapter port opening from debris ingress to help prevent distortion of a light signal between opposing optical fiber configured as part of opposing fiber optic connectors within opposing adapter ports. The dust shutter plate is biased closed covering adapter opening when a fiber optic connector, such as a LC connector is not fully inserted into the adapter port. In a first embodiment, a spring plate biases the dust shutter plate assembly forward. The spring plate is configured to ensure the dust shutter plate assembly is angled to make contact with the LC fiber optic connector plug frame or outer housing holding a ferrule assembly having a ferrule endface to be protected from debris or being distorted or scratched when the ferrule would otherwise contact the dust shutter plate surface.

In a second embodiment, the dust shutter plate surface has a thin cleaning film thereon that removes dust and other debris from the ferrule endface, and further helps prevent scratching or damage to the ferrule endface when the ferrule endface does not contact the hard dust shutter plate surface. Dust shutter plate surfaces are made out of a hard plastic or thin metal sheet to block light, form a more complete seal with the adapter port opening dimensions and not to become distorted after multiple uses or insertions and removals of fiber optic connectors.

### BRIEF DESCRIPTION OF THE DRAWINGS

FIG. 1 depicts an adapter with a dust shutter plate biased closed within each opening of the adapter port;

FIG. 2 is an exploded view of FIG. 1;

FIG. 3A depicts a front view of FIG. 1;

FIG. 3B depicts a cross-section view of FIG. 1;

FIG. 4A depicts dust shutter plates as if a fiber optic connector was positioned within each adapter port;

FIG. 4B is a cross-section view of FIG. 4A;

FIG. 5A depicts a dual dust shutter plate assembly without a cleaning surface;

FIG. 5B depicts a dual dust shutter plate assembly with a cleaning surface;

FIG. 6A depicts dust shutter plate biased closed just prior to insertion of a fiber optic connector within an adapter port;

FIG. 6B depicts plug frame biasing opening dust shutter plate;

FIG. 6C depicts fiber optic connector fully inserted into adapter port;

FIG. 7A depicts prior art ferrule endface cuts that can be used with the present invention;

FIG. 7B is Table A of light transmission performance of FIG. 7A cuts;

FIG. 8 depicts a top view just prior to the insertion of the duplex fiber optic connector into adapter deploying the present invention;

FIG. 9A is a top view of dust shutter plate assembly inserted into the adapter body;

FIG. 9B depicts inserting a spring plate into the dust shutter plate base;

FIG. 9C depicts the spring plates secured within plate base of FIG. 9B;

FIG. 10 depicts adapter assembly with dust shutter plate according another embodiment of the present invention;

FIG. 11 depicts dust shutter plates with grooves, and

FIG. 12 depicts cut-away view of FIG. 11 dust shutter plates biased closed.

### DETAILED DESCRIPTION

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below. A connector, as used herein, refers to a device and/or components thereof that connects a first module or cable to a second module or cable. The connector may be configured for fiber optic transmission or electrical signal transmission. The connector may be any suitable type now known or later developed, such as, for example, a ferrule connector (FC), a fiber distributed data interface (FDDI) connector, an LC connector, a mechanical transfer (MT) connector, a square connector (SC) connector, an SC duplex connector, an MPO connector, or a straight tip (ST) connector. The connector may generally be defined by a connector housing body. In some embodiments, the housing body may incorporate any or all of the components described herein.

A “fiber optic cable” or an “optical cable” refers to a cable containing one or more optical fibers for conducting optical signals in beams of light. The optical fibers can be constructed from any suitable transparent material, including glass, fiberglass, and plastic. The cable can include a jacket or sheathing material surrounding the optical fibers. In addition, the cable can be connected to a connector on one end or on both ends of the cable. As used herein, the term “optical fiber” is intended to apply to all types of single mode and multi-mode light waveguides, including one or more bare optical fibers, coated optical fibers, loose-tube optical fibers, tight-buffered optical fibers, ribbonized optical fibers, bend performance optical fibers, bend insensitive optical fibers, nanostructured optical fibers or any other expedient for transmitting light signals.

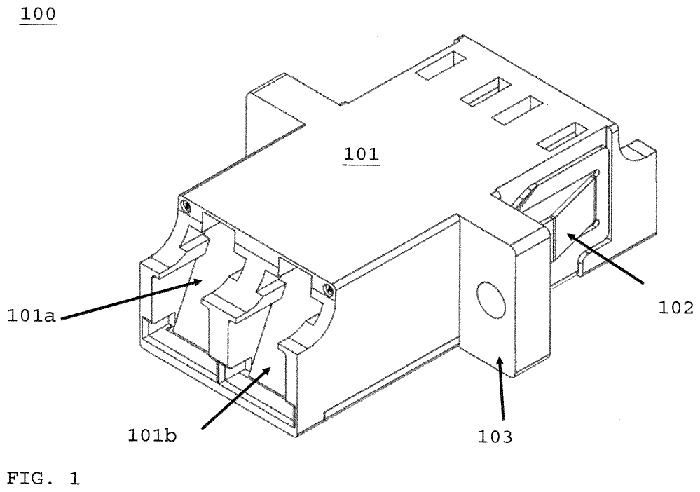

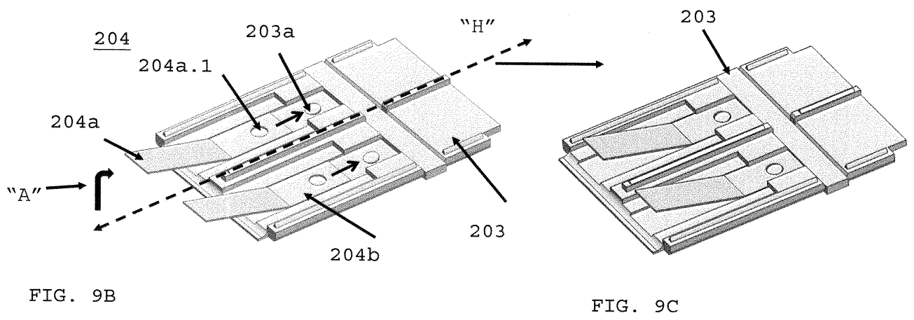

FIG. 1 depicts an adapter (100) with a dual dust shutter plate assembly (refer to FIGS. 10A-10C) secured within adapter housing (101). Dust shutter plate (101a, 110b) is biased closed at an angle to help prevent ferrule endface (621) from connecting a surface of the dust shutter plate (101a, 101b). Adapter housing (101) has panel mount clip (102) and flange (103) to secure the adapter to a panel to form an array of adapter within a data center.

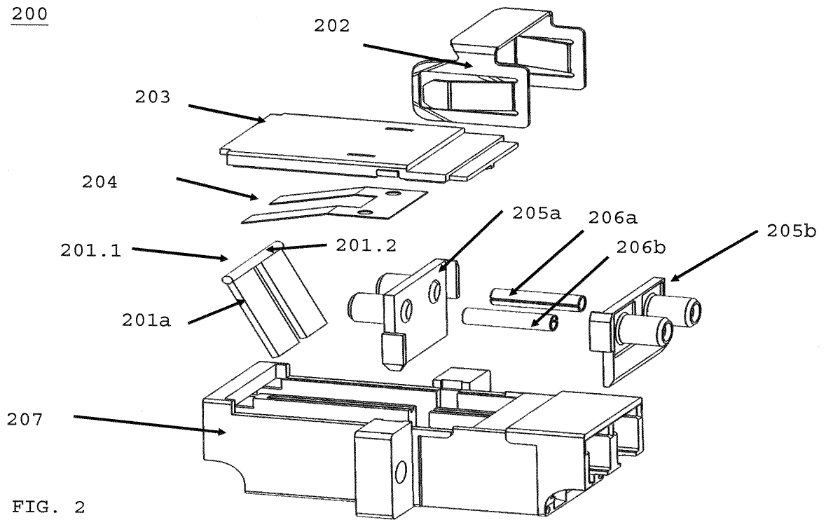

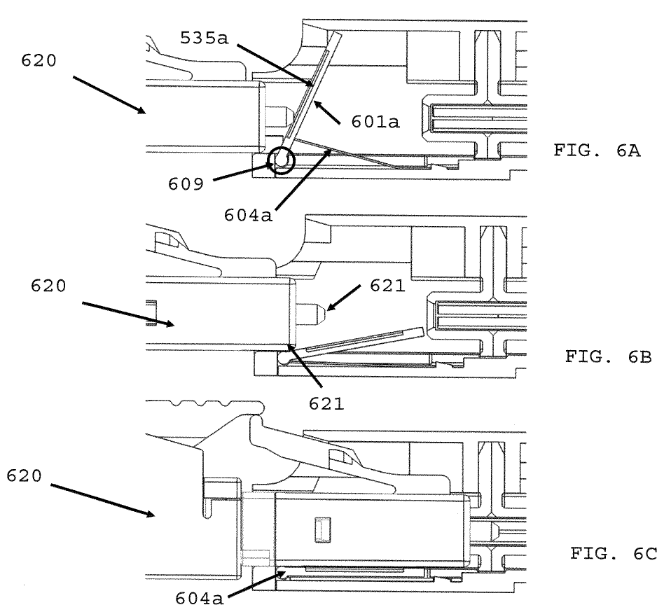

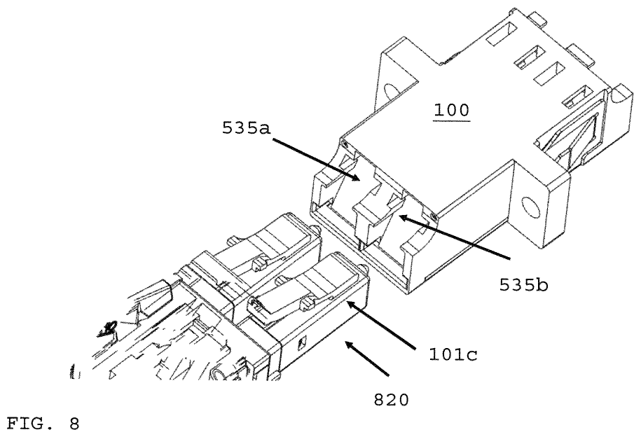

FIG. 2 depicts an exploded view of adapter (100). Adapter lower body (207) is configured to accept alignment sleeve holder assembly (205a, 205b). Assembly (205a, 205b) accepts one or more alignment sleeves (206a, 206b). Sleeves (206a, 206b) are configured to accept ferrule (101c) at a proximal end of fiber optic connector (620, 820) (refer to FIG. 6 and FIG. 8). Dust shutter plate assembly (201.1) connects two or more dust shutter plate (201a, 201b) along pivot arm (201.2). Spring plate assembly (204) with flexible arms (204a, 204b) angled to bias close shutter plates (201a, 201b) respectively. Flexible arms (204a, 204b) are angled to bias close the shutter plates from twenty (20) degrees to forty (40) degrees angle “A” from the horizontal “H” of adapter cover plate (203).

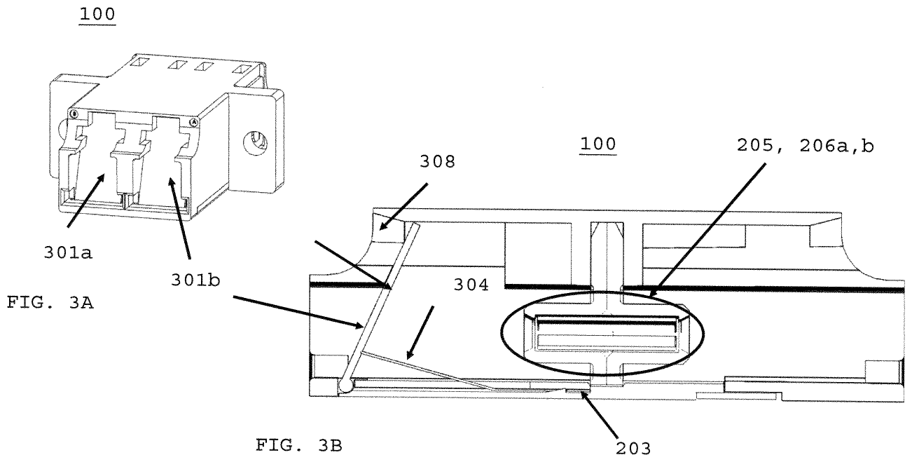

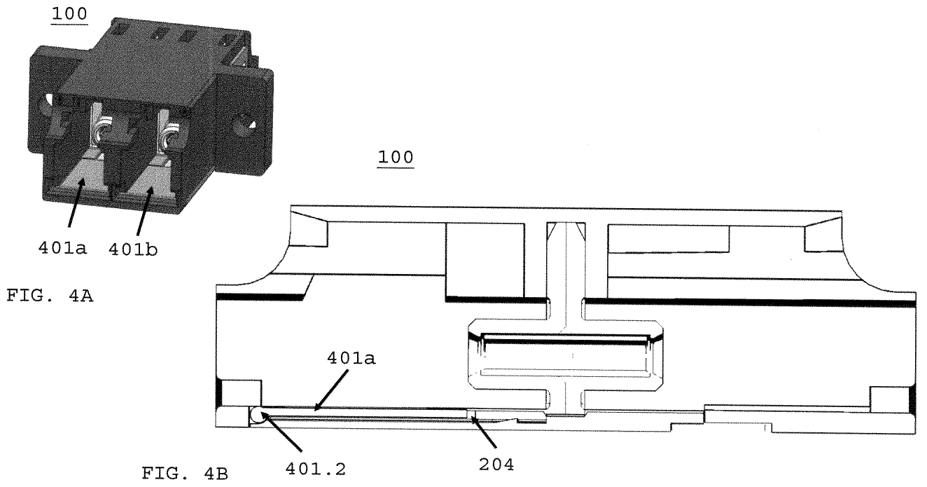

FIG. 3A depicts shutter plate (301b) closed under bias force of bias spring (304). This helps prevent debris ingress within the adapter port. FIG. 3B depicts cross-section view of FIG. 1. Spring plate assembly (304) biases close plate (301a), which is stopped by inner adapter housing frame (308). FIG. 4A is a front view of dust shutter plates (401a, 401b) compressed or pushed within opening (204) of the adapter cover plate under the force of a fiber optic connector (not shown). FIG. 4B is a cross-section of FIG. 4A with plate (401a) on pivot arm (401.2) in collapsed position after full insertion of a fiber optic connector (not shown).

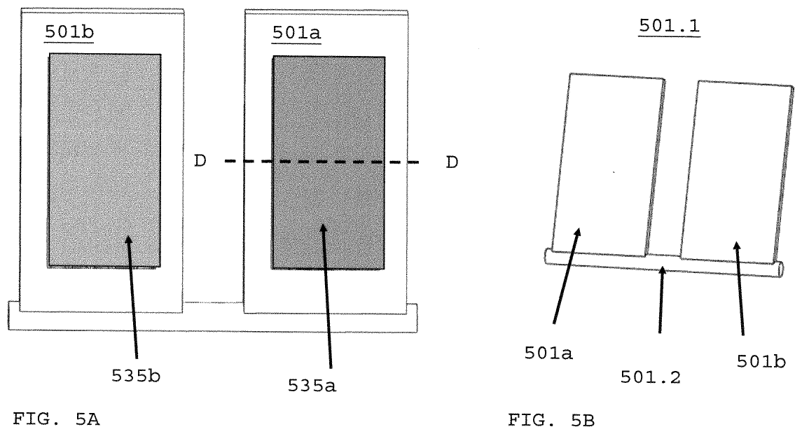

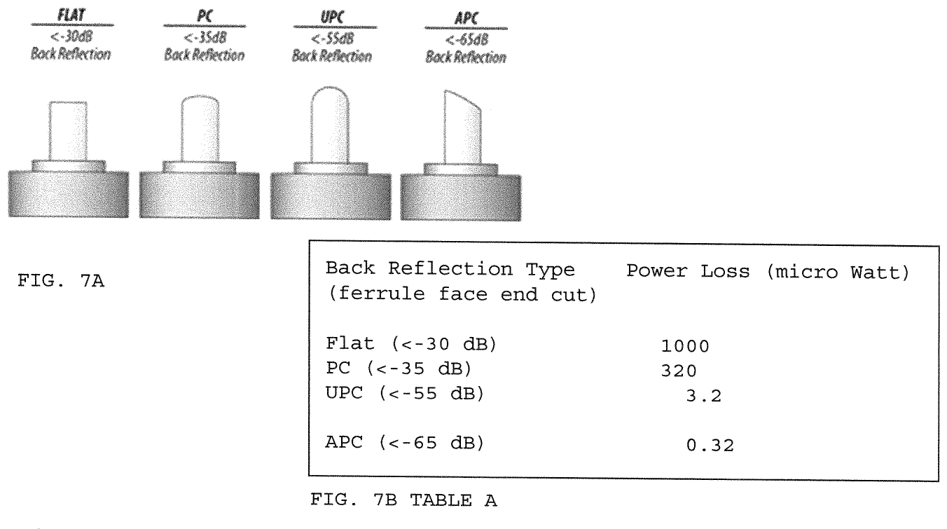

FIG. 5A depicts a dust shutter plate assembly with dual dust shutter plate (501a, 501b) with coating or film (535a, 535b) on the surface of the plate. The coating may be an anti-static cloth, a thin film of anti-reflective gel or absorbent gel to remove and accumulate debris at ferrule endface (621). FIG. 5B depicts dust shutter assembly (501.1) without out a coating on plates (501a, 501b). FIG. 6A depicts dust shutter plate (601a) with coating (535a) on the connector facing side of plate (601a), and the flexible arm (604a) of spring plate (604) biasing shutter plate (601a) at angle such that ferrule endface (621) contacts coating (535a) to remove debris on the ferrule endface, and to apply an anti-reflective coating onto ferrule endface to improve or reduce insertion loss and reduce reflective loss of the light signal transmitted within an optical fiber of the ferrule. FIG. 6B depicts fiber optic connector (620) plug frame (621) contacting dust shutter plate (601a) below coating (535a) so that ferrule endface does not scratch or become damaged striking the ferrule endface and thereby damaging the optical fiber therein. Within the ferrule end face is a slight depression that can trap debris and the when coating (535) is positioned at the endface and within the slight depression the gel that improves light signal performance, by reducing losses (above) is deposited after the debris is removed. Coating (535) may be an upper half of cloth and a lower half of gel as depicted along dividing line “D-D” of FIG. 5A. Other variations materials and combinations of coatings maybe deployed. FIG. 6C depicts fiber optic connector (620) fully inserted into the adapter port, with the ferrule secured with the alignment sleeve. The dust plate and the spring arm are both secured with the opening of the adapter cover under the plug frame, along pivot arm (604a). FIG. 7A is a prior art view of various ferrule endfaces deployed in fiber optic connectors using the present invention. By the ferrule endface, the signal loss measure in decibels is reduced with an APC or angled physical cut ferrule endface. Flat is flat cut; PC is partial cut and UPC is ultra physical contact cut. With reduced signal loss is a reduction in power loss measured in microwatt. The lower the losses the further apart receivers and transmitters can be placed reducing over network costs by reducing the number of expensive electronic devices. FIG. 7B Table A depicts numeric losses by ferrule endface cut under optimal conditions of no debris on a ferrule endface. Overtime debris collects and losses can be as high as 30%, so repeated debris remove upon insertion of a fiber connector within an adapter can keep a system near optimal signal output. By adding a gel can improve transmission losses by reducing them 10-15%.

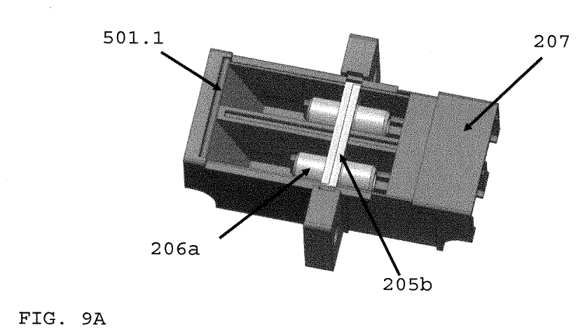

FIG. 8 depicts duplex fiber optic connector (820) prior to insertion into adapter (100) deploying the present invention dust shutter plates with coating (535a, 535b). The angle of the dust shutter plates is set to allow the ferrule endface to contact the coating, and then plug frame (101c) strikes the plate as described in FIG. 6 above. FIG. 9A depicts dual dust shutter plate assembly (501.1) inserted into adapter body (207). FIG. 9B depicts securing flexible arms (204a, 204b) to adapter cover plate (203) using cut-outs (204a.1) accepted within protrusion (203a) formed within the cover plate. FIG. 9C depicts the flexible arms secured within channels or slots formed in the cover plate (203).

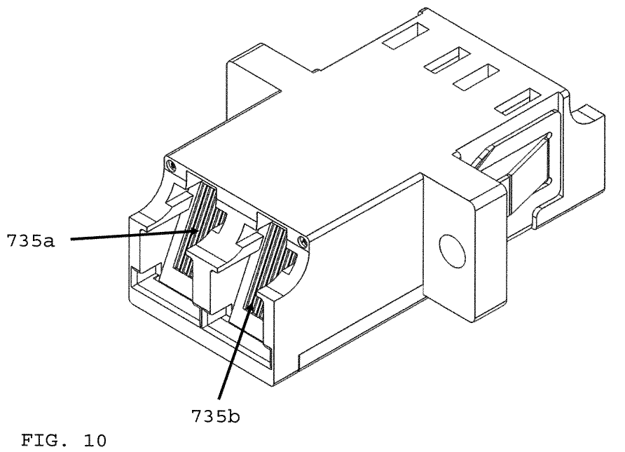

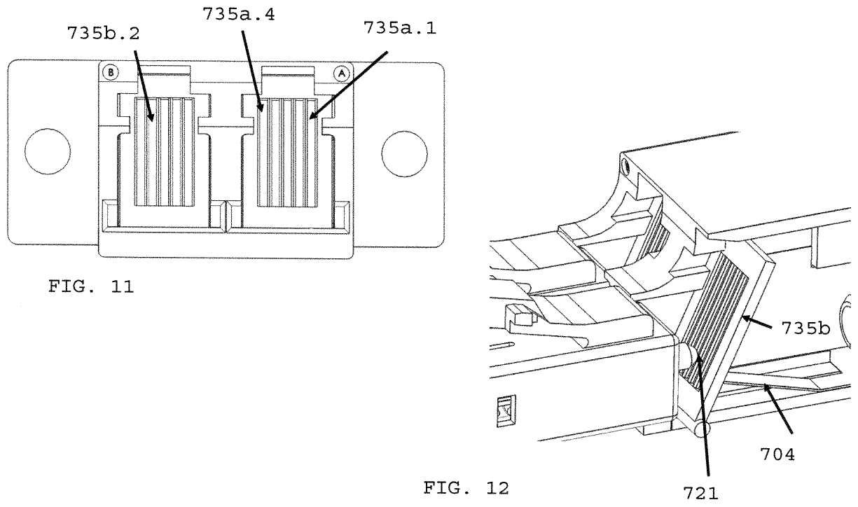

FIG. 10 depicts an adapter assembly with a dust shutter plate assembly with grooved plates (735a, 735b). FIG. 11 depicts a front view of FIG. 10 with groove (735b.2) formed in dust shutter plate (735b) and grooves (735a.1-735a.4) in plate (735a). The grooves reduce the contact of dust shutter plate (735b) surface with ferrule endface (721). The grooves maybe filled with the transmission gel or a cloth to improve signal transmission and/or remove debris at the ferrule endface.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

1. An adapter assembly with a dust shutter plate comprising:
the at least one shutter plate on a pivot bar positioned forward in a receptacle port of the adapter;
the plate further comprises a coating; and
wherein the dust shutter plate is biased closed by a spring plate.

2. The adapter assembly with a dust shutter plate according to claim 1, wherein the adapter has a plural of ports each with the dust shutter plate.

3. The adapter assembly with a dust shutter plate according to claim 1, wherein the coating is a debris free, dry cloth.

4. The adapter assembly with a dust shutter plate according to claim 3, wherein the coating further includes an alcohol solution.

5. The adapter assembly with a dust shutter plate according to claim 3, wherein the coating further includes a gel for reducing signal loss.

6. The adapter assembly with a dust shutter plate according to claim 5, wherein the shutter plate is angled to make a substantial perpendicular contact with an optical fiber embedded in a ferrule endface and near the surface of a tip of the ferrule endface secured within a fiber optic connector.

7. The adapter assembly with a dust shutter plate according to claim 6, wherein the angle is between 20 to 40 degrees depending on a ferrule endface type further selected from a group of: FLAT, partial cut (PC), ultra physical contact (UPC) and angled physical contact (APC).

8. The adapter assembly with a dust shutter plate according to claim 1, wherein the dust shutter plate surface has a plural of grooves.

9. An adapter assembly resulting in the configuration of claim 1.

10. A method of cleaning debris from a ferrule endface with one or more embedded optical fibers comprising:
providing an adapter assembly according to claim 9;
inserting a fiber optic connector into a receptacle port of the adapter assembly;
setting a spring plate at an angle between 20 and 40 degrees;
contacting a coating on a dust shutter plate with the ferrule endface; and
pushing the fiber optic connector not the adapter thereby removing debris from the ferrule endface and applying a gel to improve optical transmission to the ferrule endface.

11. The method of cleaning debris from a ferrule endface with one or more embedded optical fibers according to claim 10, wherein the gel reduces insertion loss and reflective loss.
